(19) United States
(12) Patent Application Publication
(10) Pub. No.: US 2018/0153225 A1
(43) Pub. Date: Jun. 7, 2018

(54) Infant Bib System

(71) Applicant: Trudie Walsh, Lake City, MI (US)

(72) Inventor: Trudie Walsh, Lake City, MI (US)

(21) Appl. No.: 15/366,060

(22) Filed: Dec. 1, 2016

(51) Int. Cl. A41B 13/10; A61J 17/00

(52) U.S. Cl. CPC A41B 13/10; A61J 17/001

(57) ABSTRACT

An infant bib system for inhibiting a pacifier from falling on a floor includes a bib that is worn on a child. A strap is coupled to the bib. A pacifier is provided to be sucked by the child thereby facilitating the pacifier to soothe the child. The pacifier is selectively attached to the strap to inhibit the pacifier from being dropped when the child releases the pacifier.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to bib devices and more particularly pertains to a new bib device for inhibiting a pacifier from being dropped on a floor.

### BRIEF SUMMARY OF THE INVENTION

An embodiment of the disclosure meets the needs presented above by generally comprising a bib that is worn on a child. A strap is coupled to the bib. A pacifier is provided to be sucked by the child thereby facilitating the pacifier to soothe the child. The pacifier is selectively attached to the strap to inhibit the pacifier from being dropped when the child releases the pacifier.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an infant bib system according to an embodiment of the disclosure.

FIG. 2 is a back view of an embodiment of the disclosure.

FIG. 3 is a front perspective view of an embodiment of the disclosure.

FIG. 4 is a perspective in-use view of an embodiment of the disclosure.

### DETAILED DESCRIPTION OF THE INVENTION

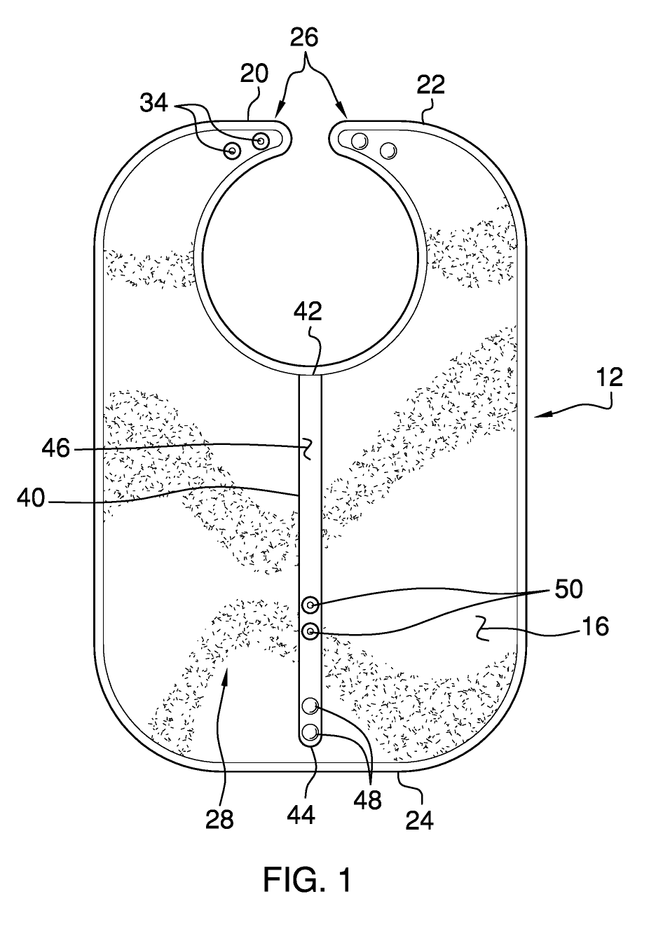

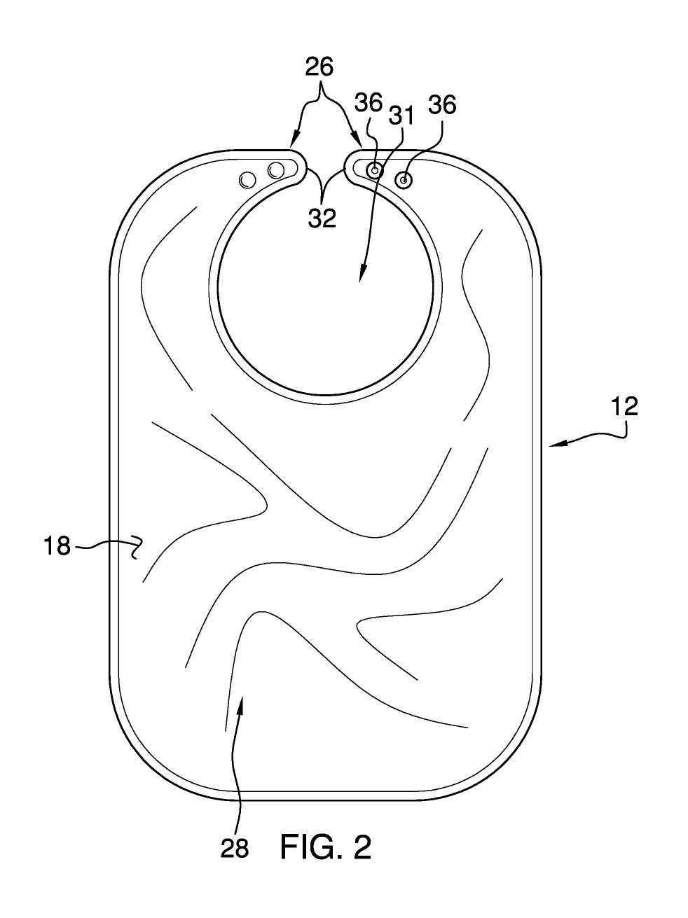

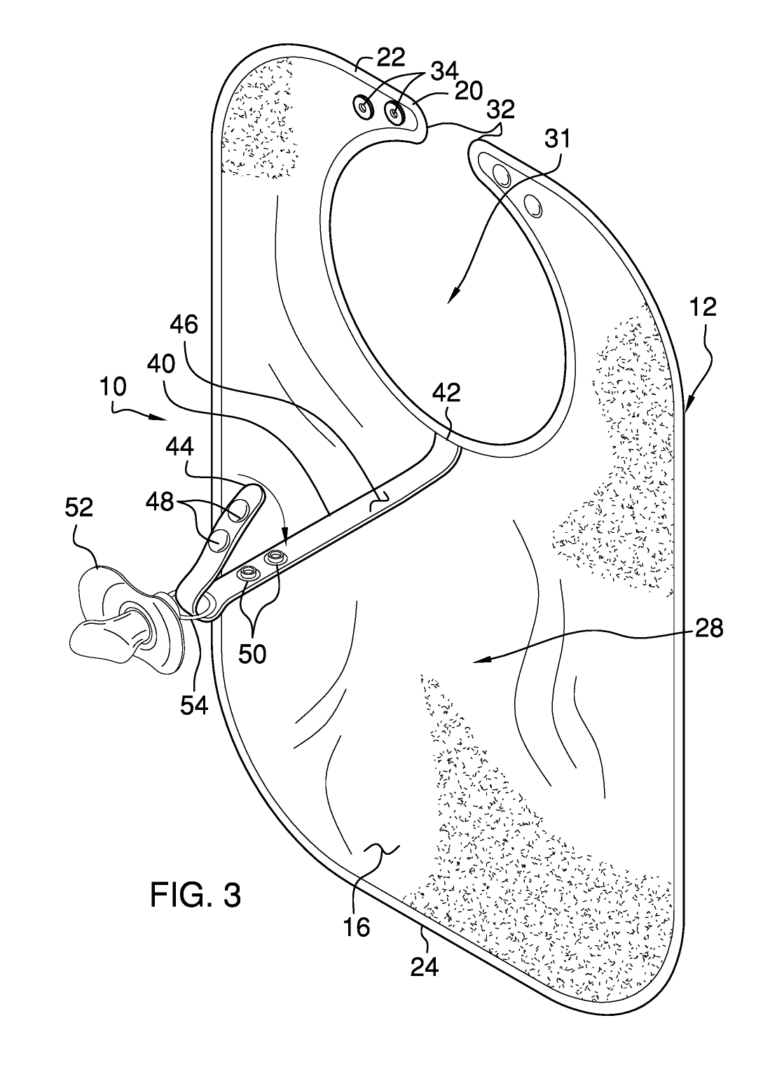

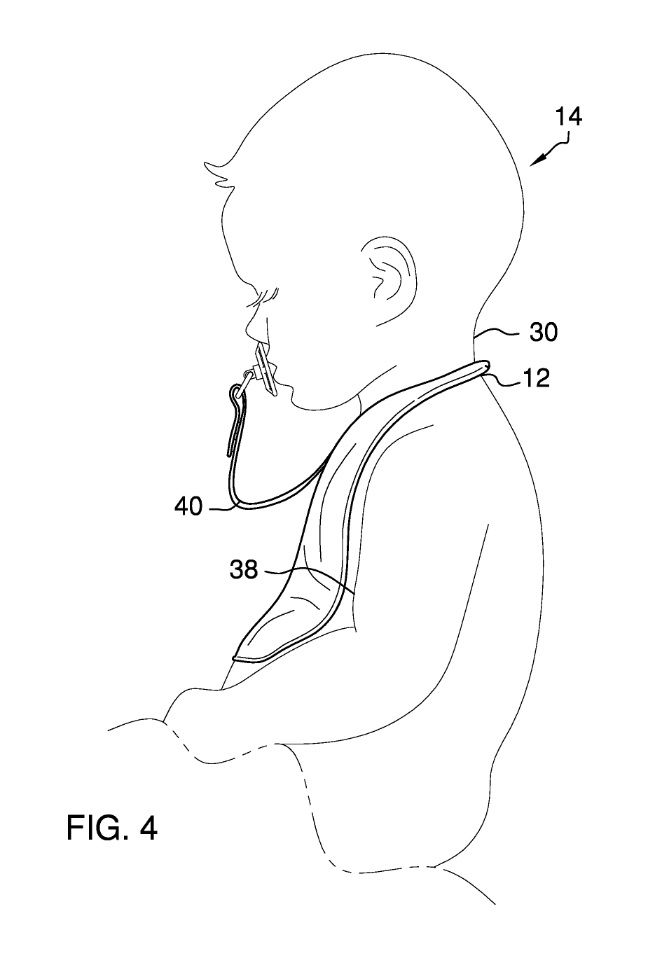

With reference now to the drawings, and in particular to FIGS. 1 through 4 thereof, a new bib device embodying the principles and concepts of an embodiment of the disclosure and generally designated by the reference numeral 10 will be described.

As best illustrated in FIGS. 1 through 4, the infant bib system 10 generally comprises a bib 12 that may be worn on a child 14. The bib 12 has a front surface 16, a back surface 18 and a peripheral edge 20 extending therebetween. The peripheral edge 20 has a top side 22 and a bottom side 24. The top side 22 extends downwardly toward the bottom side 24 to define a pair of horns 26 each extending upwardly from a panel portion 28. The bib 12 is comprised of a fluid absorbent material to inhibit saliva from the child 14 from soaking the child 14′s clothing. The back surface 18 of the bib is comprised of a fluid impermeable material to inhibit the saliva from passing through the bib 12.

The top side 22 corresponding to each of the horns 26 is concavely arcuate to define a circle 29 between each of the horns 26. The circle 29 is placed around a neck 30 of the child 14 having each of the horns 26 extending around the child's neck 30. Each of the horns 26 has a first end 32 and the first end 32 corresponding to each of the horns 26 is directed toward each other.

A pair of first mating members 34 is provided and each of the first mating members 34 is coupled to the front surface 16 corresponding to an associated one of the horns 26. Each of the first mating members 34 is positioned adjacent to the first end 32 of the associated horn 26. A pair of second mating members 36 is provided and each of the second mating members 36 is coupled to the back surface 18 corresponding to an associated one of the horns 26. Each of the second mating members 36 is positioned adjacent to the first end 32 of the associated horn 26. Each of the first mating members 34 is matable with the second mating members 36. Thus, each of the horns 26 is retained around the child's neck 30 having the panel portion 28 extending downwardly along a body 38 of the child 14. Each of the first mating members 34 and the second mating members 36 may be a snap button or the like.

A strap 40 is provided and the strap 40 is coupled to the bib 12. The strap 40 has a first end 42, a second end 44 and a first surface 46. The first end 32 is coupled to the peripheral edge 20 corresponding to the circle 29 having the strap 40 extending downwardly along the front surface 16 corresponding to the panel portion 28. Moreover, the strap 40 is centrally positioned on the panel portion 28.

A pair of third mating members 48 is provided and each of the third mating members 48 is coupled to the first surface 46 of the strap 40. Each of the third mating members 48 is aligned with the second end 44 of the strap 40. A pair of fourth mating members 50 is provided and each of the fourth mating members 50 is coupled to the first surface 46 of the strap 40. Each of the fourth mating members 50 is positioned between the third mating members 48 and the first end 32 of the strap 40. Each of the third mating members 48 is matable with the fourth mating members 50 such that the strap 40 forms a closed loop between the third mating members 48 and the fourth mating members 50. Moreover, each of the third mating members 48 and each of the fourth mating members 50 may be snap button or the like.

A pacifier 52 is provided and the pacifier 52 may be sucked by the child 14 thereby facilitating the pacifier 52 to soothe the child 14. The pacifier 52 has a ring 54 thereon. The strap 40 is extended through the ring 54 and the third mating members 48 are mated to the fourth mating members 50. Thus, the pacifier 52 is coupled to the strap 40 to inhibit the pacifier 52 from being dropped when the child 14 releases the pacifier 52.

In use, the bib 12 is placed on the child 14 and the first 34 and second 36 mating members are mated together. The second end 44 of said strap 40 is extended through the ring 54 on the pacifier 52. Each of the third mating members 48 is mated to the fourth mating members 50 to retain the pacifier 52 on the strap 40. The child 14 sucks on the pacifier 52 and the strap 40 inhibits the pacifier 52 from falling on a floor or the like when the child 14 drops the pacifier 52. Thus, the strap 40 inhibits the pacifier 52 from coming into contact with bacteria or dirt on the floor.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An infant bib system combining a pacifier and a bib, said system comprising:
a bib being configured to be worn on a child;
a strap being coupled to said bib; and
a pacifier being configured to be sucked by the child thereby facilitating said pacifier to soothe the child, said pacifier being selectively attached to said strap wherein said strap is configured to inhibit said pacifier from being dropped when the child releases said pacifier.

2. The system according to claim 1, wherein said bib has a front surface, a back surface and a peripheral edge extending therebetween, said peripheral edge having a top side and a bottom side, said top side extending downwardly toward said bottom side to define a pair of horns each extending upwardly from a panel portion, said top side corresponding to each of said horns being concavely arcuate to define a circle between each of said horns wherein said circle is configured to be placed around a neck of the child having each of said horns extending around the child's neck, each of said horns having a first end, said first end corresponding to each of said horns being directed toward each other.

3. The system according to claim 2, further comprising a pair of first mating members, each of said first mating members being coupled to said front surface corresponding to an associated one of said horns, each of said first mating members being positioned adjacent to said first end of said associated horn.

4. The system according to claim 3, further comprising a pair of second mating members, each of said second mating members being coupled to said back surface corresponding to an associated one of said horns, each of said second mating members being positioned adjacent to said first end of said associated horn, each of said first mating members being matable with said second mating members such that each of said horns is retained around the child's neck having said panel portion extending downwardly along a body of the child.

5. The system according to claim 2, further comprising said strap having a first end, a second end and a first surface, said first end being coupled to said peripheral edge corresponding to said circle having said strap extending downwardly along said front surface corresponding to said panel portion.

6. The system according to claim 5, further comprising a pair of third mating members, each of said third mating members being coupled to said first surface of said strap, each of said third mating members being aligned with said second end of said strap.

7. The system according to claim 6, further comprising a pair of fourth mating members, each of said fourth mating members being coupled to said first surface of said strap, each of said fourth mating members positioned between said third mating members and said first end of said strap, each of said third mating members being matable with said fourth mating members such that said strap forms a closed loop between said third mating members and said fourth mating members.

8. The system according to claim 7, wherein said pacifier has a ring thereon, said strap being extended through said ring when said third mating members are mated to said fourth mating members such that said pacifier is coupled to said strap.

9. An infant bib system combining a pacifier and a bib, said system comprising:
a bib being configured to be worn on a child, said bib having a front surface, a back surface and a peripheral edge extending therebetween, said peripheral edge having a top side and a bottom side, said top side extending downwardly toward said bottom side to define a pair of horns each extending upwardly from a panel portion, said top side corresponding to each of said horns being concavely arcuate to define a circle between each of said horns wherein said circle is configured to be placed around a neck of the child having each of said horns extending around the child's neck, each of said horns having a first end, said first end corresponding to each of said horns being directed toward each other;
a pair of first mating members, each of said first mating members being coupled to said front surface corresponding to an associated one of said horns, each of said first mating members being positioned adjacent to said first end of said associated horn;
a pair of second mating members, each of said second mating members being coupled to said back surface corresponding to an associated one of said horns, each of said second mating members being positioned adjacent to said first end of said associated horn, each of said first mating members being matable with said second mating members such that each of said horns is retained around the child's neck having said panel portion extending downwardly along a body of the child;
a strap being coupled to said bib, said strap having a first end, a second end and a first surface, said first end being coupled to said peripheral edge corresponding to said circle having said strap extending downwardly along said front surface corresponding to said panel portion;
a pair of third mating members, each of said third mating members being coupled to said first surface of said strap, each of said third mating members being aligned with said second end of said strap;
a pair of fourth mating members, each of said fourth mating members being coupled to said first surface of said strap, each of said fourth mating members positioned between said third mating members and said first end of said strap, each of said third mating members being matable with said fourth mating members such that said strap forms a closed loop between said third mating members and said fourth mating members; and
a pacifier being configured to be sucked by the child thereby facilitating said pacifier to soothe the child, said pacifier having a ring thereon, said strap being extended through said ring when said third mating members are mated to said fourth mating members such that said pacifier is coupled to said strap wherein said strap is configured to inhibit said pacifier from being dropped when the child releases said pacifier.
